(19) United States
(12) Patent Application Publication
(10) Pub. No.: US 2024/0142255 A1
(43) Pub. Date: May 2, 2024

(54) DISPLAY CONTROL DEVICE, DISPLAY CONTROL SYSTEM, DISPLAY CONTROL METHOD, AND STORAGE MEDIUM

(71) Applicant: Panasonic Intellectual Property Management Co., Ltd., Osaka (JP)

(72) Inventors: Yota KAMBAYASHI, Osaka (JP); Tadahiro UCHIKOSHI, Tokyo (JP); Kazunori TANAKA, Kanagawa (JP); Daiki MATSUDA, Osaka (JP); Kazuki ONISHI, Osaka (JP)

(73) Assignee: Panasonic Intellectual Property Management Co., Ltd., Osaka (JP)

(21) Appl. No.: 18/383,721

(22) Filed: Oct. 25, 2023

(30) Foreign Application Priority Data
Nov. 2, 2022 (JP) 2022-176087

(51) Int. Cl. G01C 21/36; G06F 3/01; G09G 5/34

(52) U.S. Cl. CPC G01C 21/3629; G01C 21/3652; G06F 3/013; G09G 5/34; G09G 2320/0666; G09G 2340/045; G09G 2340/0464; G09G 2354/00; G09G 2380/10

(57) ABSTRACT

A display control device includes a driving plan setter and a notification controller. The driving plan setter sets the driving plan of a vehicle equipped with a display from a departure point to a destination. The notification controller controls the display that displays the driving plan. When the driving plan setter changes the driving plan, the notification controller causes the display to display a changed driving plan, by controlling the display. The notification controller includes an emphasis display enabler that causes the display to display the changed driving plan in an emphasized manner, when the driving plan is changed by the driving plan setter.

### CROSS REFERENCE TO RELATED APPLICATION

The present application is based on and claims priority of Japanese Patent Application No. 2022-176087 filed on Nov. 2, 2022.

### FIELD

The present disclosure relates to a display control device, a display control system, a display control method, and a storage medium.

### BACKGROUND

Patent Literature 1 (PTL 1) discloses a display control device for use in a vehicle, the display control device including a controller that causes a first display provided inside an occupant compartment of the vehicle to display the scheduled operations of the vehicle and causes a second display provided inside the occupant compartment to display a scheduled operation in which at least one of the distance to the point at which the scheduled operation will be performed and the length of time until the scheduled operation is less than or equal to a predetermined value, out of the scheduled operations, the second display being different from the first display.

### CITATION LIST

### Patent Literature

PTL 1: Japanese Patent No. 6825683

### SUMMARY

The display control device for use in a vehicle, according to PTL 1 can be improved upon.

A display control device, a display control system, a display control method, and a storage medium according to the present disclosure are capable of improving upon the above related art.

A display control device according to one aspect of the present disclosure includes a processor and a memory including at least one program that, when executed by the processor, causes the processor to perform operations. The operations include setting the driving plan of a vehicle from a departure point to a destination, the vehicle being equipped with a display, and controlling the display used for displaying the driving plan. When the driving plan is changed, the display is caused to display a changed driving plan, by controlling the display. The processor causes the display to display the changed driving plan in an emphasized manner when the driving plan is changed.

A display control system according to another aspect of the present disclosure includes the display control device and one or more displays included in the vehicle.

A display control method according to still another aspect of the present disclosure includes setting the driving plan of a vehicle from a departure point to a destination, the vehicle being equipped with a display, controlling the display used for displaying the driving plan, causing the display to display a changed driving plan, by controlling the display, when the driving plan is changed, and causing the display to display the changed driving plan in an emphasized manner, when the driving plan is changed.

A recording medium according to still another aspect of the present disclosure is a non-transitory computer-readable storage medium having recorded thereon a program for causing a computer to execute the display control method.

The display control device, the display control system, the display control method, and the storage medium according to the aspects of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic view illustrating an in-vehicle display control system according to an embodiment.

FIG. 2 is a block diagram illustrating a hardware configuration of the display control system according to the embodiment.

FIG. 3 is a block diagram illustrating a functional configuration of the display control system according to the embodiment.

FIG. 4 illustrates a state in which a changed driving plan is notified after a driving plan is changed.

FIG. 5 is a flowchart illustrating processing operation of the display control system according to the embodiment.

### DESCRIPTION OF EMBODIMENT

It should be noted that the embodiment described below shows a general or specific example of the present disclosure. The numerical values, shapes, materials, structural elements, the arrangement and connection of the structural elements, steps, order of the steps, and other descriptions indicated in the following embodiment are mere examples, and therefore do not intend to limit the present disclosure. In addition, among structural elements in the following embodiment, those not recited in any of the independent claims are described as optional structural elements.

The drawings are schematic views and are not necessarily precise illustrations. In the drawings, substantially the same structural elements are assigned the same reference symbol.

An embodiment of the present disclosure is described below in detail with reference to the drawings.

### EMBODIMENT

### <Functional Configuration>

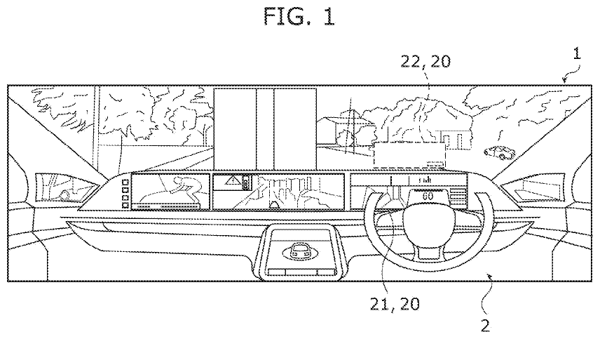

Display control system 1 according to the embodiment is described below with reference to FIGS. 1 to 4.

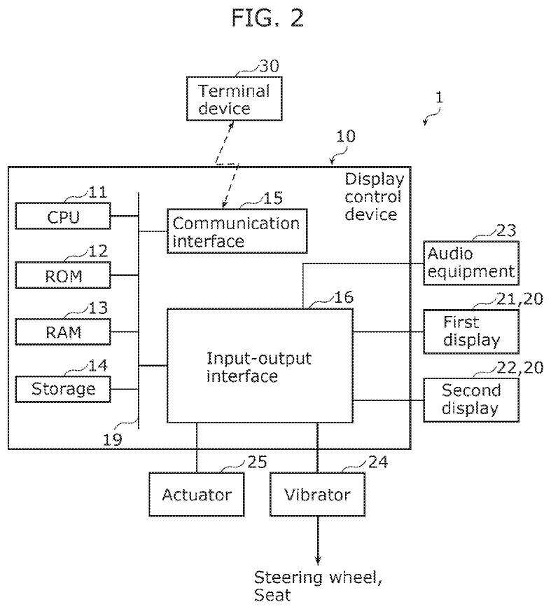

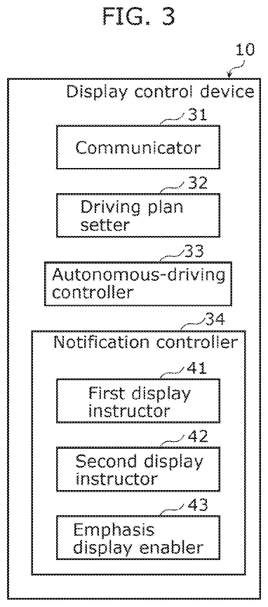

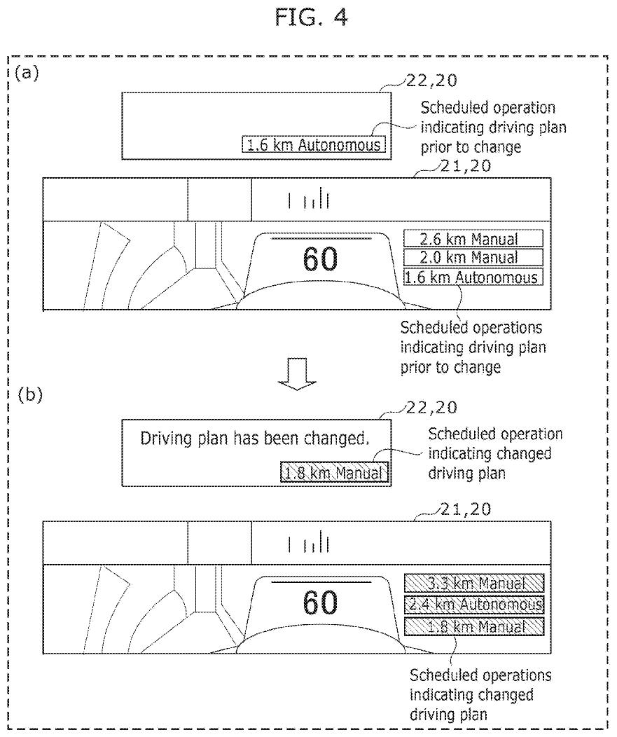

FIG. 1 is a schematic view illustrating display control system 1 according to the embodiment disposed in vehicle 2. FIG. 2 is a block diagram illustrating a hardware configuration of display control system 1 according to the embodiment. FIG. 3 is a block diagram illustrating a functional configuration of display control system 1 according to the embodiment. FIG. 4 illustrates a state in which a changed driving plan is notified after a driving plan is changed. (a) in FIG. 4 illustrates a state in which first display 21 and second display 22 are displaying display content showing the driving plan prior to the change, whereas (b) in FIG. 4 illustrates a state in which first display 21 and second display 22 are displaying display content showing the changed driving plan.

As illustrated in FIG. 1, display control system 1 can display images on one or more displays 20. In display control system 1, display images can be displayed on one or more displays 20 automatically or manually by an occupant. In addition, display control system 1 is used in, for example, vehicle 2 in which one or more displays 20 are arranged.

In the embodiment, images displayed by one or more displays 20 are images based on applications and include information items such as vehicle instrument information, the operation status of each in-vehicle device, navigation information, a captured image, and nearby vehicle information. Vehicle instruments include, for example, a speedometer, a direction indicator lamp, an idiot light, an odometer, a shift position indicator, a fuel gauge, and a water temperature gauge. In-vehicle devices include, for example, audio equipment, an in-vehicle lighting device, and a seat device. The navigation information is information for informing a user of, for example, the present location and route guidance to a destination during driving of vehicle 2. The captured image is an image of at least a portion of the surroundings of vehicle 2 or at least a portion of the interior of the occupant compartment of vehicle 2, captured by an image capturing device provided in vehicle 2. The nearby vehicle information indicates, for example, whether another vehicle is present around vehicle 2, the number of vehicles present around vehicle 2, the traveling speed of another vehicle, and the distance from vehicle 2 to another vehicle.

### [Hardware Configuration of Display Control System 1]

As illustrated in FIG. 2, display control system 1 includes display control device 10, displays 20, audio equipment 23, and vibrator 24.

Display control device 10 is embodied as an arithmetic processing unit such as an electronic control unit (ECU).

Display control device 10 includes a central processing unit (CPU) 11 (also referred to as a central processor), read only memory (ROM) 12, random access memory (RAM) 13, storage 14, communication interface 15, and input-output interface 16. CPU 11, ROM 12, RAM 13, storage 14, communication interface 15, and input-output interface 16 are communicably connected to each other via bus 19.

CPU 11 executes various programs. For instance, CPU 11 reads a predetermined program from ROM 12 or storage 14 and executes the predetermined program by using RAM 13 as a working area. CPU 11 also performs control and arithmetic processing in accordance with each of the various programs stored in ROM 12 or storage 14.

ROM 12 is used to store the various programs to be executed by CPU 11 and various data items.

RAM 13 is used as working area to temporarily store the various programs or the various data items.

Storage 14 is a hard disk drive (HDD) or a solid-state drive (SSD). Storage 14 is used to store, for example, various programs including an operating system and the various data items.

In the embodiment, for instance, ROM 12 or storage 14 is used to store, for example, various programs for use in image display processing for displays 20 and various data items.

Communication interface 15 is an interface for enabling communication with an external server (not illustrated) and another terminal device. For instance, Ethernet (registered trademark), LTE, FDDI, and Wi-Fi (registered trademark) are used as communication standards of communication interface 15.

Displays 20 (first display 21, second display 22), audio equipment 23, vibrator 24, and actuator 25 are connected to input-output interface 16.

Actuator 25 includes a steering actuator, an accelerator actuator, and a brake actuator. The steering actuator is designed to be capable of steering vehicle 2. The accelerator actuator is designed to be capable of causing vehicle 2 to accelerate. The brake actuator is designed to be capable of causing vehicle 2 to decelerate by controlling a brake.

Displays 20 are display devices, such as a personal computer (PC) equipped with a liquid crystal display, a portable terminal such as a smartphone, and a car navigation system, an electron mirror system, multi-information displays, a head-up display, and other devices which are provided in vehicle 2. FIG. 1 illustrates examples of displays 20. Specifically, FIG. 1 illustrates, as displays 20, a car navigation system disposed in the middle of the breadth of the vehicle, the electron mirror system functioning as a left sideview mirror and a right sideview mirror, and multi-information displays. Displays 20 are aligned to enable an occupant of vehicle 2 to view displays 20 all at once. Display 20 displays the driving plan of vehicle 2 from a departure point to a destination and displays a changed driving plan when the driving plan is changed. In the embodiment, first display 21 and second display 22 are used most often as examples of one or more displays 20. It should be noted that display 20 is a generic term of first display 21 and second display 22.

Audio equipment 23 is a speaker capable of outputting sound. By, for example, reading aloud display content displayed on display 20, audio equipment 23 can notify the display content or that the display content has been changed. When notifying that the display content has been changed, audio equipment 23 may just notify that the display content has been changed, notify changed display content by reading aloud, or just notify by, for example, alarm notification.

Vibrator 24 is a vibrator for vibrating at least one of a steering wheel, a seat, and other parts. When for instance the display content displayed on display 20 is changed, vibrator 24 vibrates at least one of the steering wheel, the seat, and the other parts, thereby notifying that display 20 started displaying new display content or that the display content has been changed.

### [Functional Configuration of Display Control Device 10]

As illustrated in FIGS. 2 and 3, display control device 10 achieves the functions described below, by using the aforementioned hardware configuration.

Display control device 10 includes, as functional elements, communicator 31, driving plan setter 32, autonomous driving controller 33, and notification controller 34. Each of these functional elements is achieved by CPU 11 reading and executing a program stored in ROM 12 or storage 14.

Communicator 31 communicates with an external server or another terminal device via communication interface 15. For instance, communicator 31 transmits and receives, via communication interface 15, map data or traffic data stored in the external server or another terminal device. In addition, communicator 31 communicates with another vehicle present around vehicle 2 via communication interface 15.

Driving plan setter 32 sets a driving plan of vehicle 2 from a departure point to a destination. When for instance the occupant inputs a destination via input-output interface 16 of vehicle 2, driving plan setter 32 sets a driving plan from the present location of vehicle 2 to the input destination.

In addition, driving plan setter 32 can change the driving plan. When driving plan setter 32 changes the driving plan, notification controller 34 performs control to cause display 20 to display a changed driving plan. In addition, notification controller 34 may notify the occupant of the changed driving plan, by controlling audio equipment 23 and vibrator 24. In the embodiment, displays 20, audio equipment 23, and vibrator 24 may be each referred to as a notifier as a generic term.

In accordance with the driving plan, autonomous driving controller 33 controls actuator 25 to cause vehicle 2 to autonomously drive. For instance, autonomous driving controller 33 controls actuator 25 in accordance with the driving plan, map data, traffic data, and other information, thereby causing vehicle 2 to autonomously drive from the departure point to the destination.

Notification controller 34 controls display 20 that displays the driving plan. For instance, by controlling display 20, notification controller 34 causes display 20 to display the driving plan set by driving plan setter 32. In addition, when driving plan setter 32 changes the driving plan, notification controller 34 causes display 20 to display a changed driving plan, by controlling display 20. In addition, notification controller 34 may notify the occupant of the changed driving plan, by controlling audio equipment 23 and vibrator 24. Thus, notification controller 34 causes the notifiers to notify display content indicating the driving plan.

When driving plan setter 32 changes the driving plan, notification controller 34 may notify the changed driving plan to terminal device 30 other than displays 20 included in vehicle 2 via communication interface 15.

In displays 20, when driving plan setter 32 changes the driving plan, first display instructor 41 may cause first display 21 to display display content indicating the changed driving plan, and/or second display instructor 42 may cause second display 22 to display the display content indicating the changed driving plan. The display content based on the driving plan indicates the scheduled operations of vehicle 2 to be performed in accordance with the driving plan. The scheduled operations of vehicle 2 include, for example, the setting speed of vehicle 2, the location of vehicle 2 driving on a road, a scheduled driving route, and the driving mode of vehicle 2.

As for control on audio equipment 23, when driving plan setter 32 changes the driving plan, notification controller 34 causes audio equipment 23 to output sound to emphasize the changed driving plan. That is, by controlling audio equipment 23, notification controller 34 causes audio equipment 23 to output sound to emphasize the changed driving plan. For instance, by causing audio equipment 23 to output a loud sound, notification controller 34 may notify the occupant of the changed driving plan.

As for control on vibrator 24, when driving plan setter 32 changes the driving plan, notification controller 34 causes vibrator 24 to vibrate at least one of the steering wheel, the seat, and other parts of vehicle 2 to emphasize the changed driving plan. That is, by controlling vibrator 24, notification controller 34 causes vibrator 24 to vibrate the at least one of the steering wheel, the seat, and other parts of vehicle 2 to emphasize the changed driving plan. Notification controller 34 may notify the occupant of the changed driving plan by causing vibrator 24 to abruptly vibrate the at least one of the steering wheel, the seat, and other parts.

Notification controller 34 includes first display instructor 41, second display instructor 42, and emphasis display enabler 43.

First display instructor 41 causes first display 21 to display the display content based on the driving plan set by driving plan setter 32. When driving plan setter 32 changes the driving plan, first display instructor 41 may cause first display 21 to display a changed driving plan.

For instance, first display instructor 41 causes first display 21 to display, for example, the current driving speed of vehicle 2, the setting speed of vehicle 2, an image representing vehicle 2, an image representing a nearby vehicle, the location of vehicle 2 driving on a road, sensing information detected by a sensor (not illustrated) included in vehicle 2, the distance from the present location to the destination, a scheduled driving route, and the driving mode of vehicle 2. The location of vehicle 2 can be identified by a device having a GPS function detecting the location or through communication between vehicle 2 and nearby vehicle 2. The sensor is, for example, a stereo camera, an ultrasonic sensor, a millimeter wave radar, or a laser radar. The driving mode indicates whether a driver, who is an occupant, is driving vehicle 2 in a manual driving mode or in an autonomous driving mode.

Second display instructor 42 causes second display 22 to display a scheduled operation in which at least one of a distance traveled from a present location and the length of time from now until the scheduled operation is complete has become less than or equal to a predetermined value, out of the scheduled operations of vehicle 2 based on the driving plan that first display instructor 41 has caused first display 21 to display. A scheduled operation in which the at least one of the distance traveled from the present location and the length of time from now until the scheduled operation is complete has become less than or equal to the predetermined value, is not present among the scheduled operations of vehicle 2 based on the driving plan that first display instructor 41 has caused first display 21 to display. In this case, second display instructor 42 causes second display 22 to display a scheduled operation (the most immediate scheduled operation) in which the distance or/and the time is closest to the predetermined value. When driving plan setter 32 changes the driving plan, second display instructor 42 may cause second display 22 to display a scheduled operation in which at least one of a distance traveled from a present location and the length of time from now until the scheduled operation is complete has become less than or equal to the predetermined value, out of the scheduled operations of vehicle 2 based on a changed driving plan. The predetermined value is a preset value. For the distance, the predetermined value is, for example, several hundred meters or several kilometers. For the time, the predetermined value is, for example, several tens of seconds or several hundreds of seconds.

It should be noted that first display instructor 41 and second display instructor 42 may have similar functional configurations. The functions of second display instructor 42 may be achieved by first display instructor 41, and the functions of first display instructor 41 may be achieved by second display instructor 42. Thus, for instance, first display instructor 41 may cause first display 21 to display scheduled operations, and second display instructor 42 may cause second display 22 to display, for example, the present driving speed of vehicle 2, the setting speed of vehicle 2, an image representing vehicle 2, an image representing nearby vehicle 2, the location of vehicle 2 driving on a road, sensing information detected by a sensor (not illustrated) included in vehicle 2, the distance from the present location to the destination, a scheduled driving route, and the driving mode of vehicle 2.

When driving plan setter 32 changes the driving plan, emphasis display enabler 43 causes display 20 to display a changed driving plan in an emphasized manner. In the embodiment, emphasis display enabler 43 causes first display 21 and second display 22 to display the changed driving plan in an emphasized manner. However, emphasis display enabler 43 may cause first display 21 or second display 22 to display the changed driving plan in an emphasized manner.

Examples in each of which emphasis display enabler 43 causes display 20 to display the changed driving plan in an emphasized manner are described below. Two or more of the emphasis display methods described below may be combined.

When driving plan setter 32 changes the driving plan, emphasis display enabler 43 may change the color of display content indicating the changed driving plan, to cause display 20 to display the changed driving plan in an emphasized manner. When the driving plan is changed, emphasis display enabler 43 may, for instance, change the color from the color of display content indicating the driving plan prior to the change, to another color. Specifically, emphasis display enabler 43 may use a color that makes the display content indicating the changed driving plan more noticeable for the occupant (a color that improves the occupant's visibility). Colors noticeable for the occupant are, for example, warm colors.

When driving plan setter 32 changes the driving plan, emphasis display enabler 43 may change the character size of the display content indicating the changed driving plan, to cause display 20 to display the changed driving plan in an emphasized manner. When the driving plan is changed, emphasis display enabler 43 may, for instance, change the character size from the character size of the display content indicating the driving plan prior to the change, to another character size. Specifically, emphasis display enabler 43 may enlarge the character size to make the display content indicating the changed driving plan more noticeable for the occupant (to improve the occupant's visibility).

When driving plan setter 32 changes the driving plan, emphasis display enabler 43 may change the character font of the display content indicating the changed driving plan, to cause display 20 to display the changed driving plan in an emphasized manner. When the driving plan is changed, emphasis display enabler 43 may, for instance, change the character font from the character font of the display content indicating the driving plan prior to the change, to another character font. Specifically, emphasis display enabler 43 may use a character font that makes the display content indicating the changed driving plan more noticeable for the occupant (a character font that can improve the occupant's visibility). Character fonts noticeable for the occupant include, for example, sans serif typefaces and well-designed typefaces.

When driving plan setter 32 changes the driving plan, emphasis display enabler 43 may change the display position of the display content indicating the changed driving plan, to cause display 20 to display the changed driving plan in an emphasized manner. When the driving plan is changed, emphasis display enabler 43 may, for instance, change the display position from the display position of the display content indicating the driving plan prior to the change, to another display position. Specifically, emphasis display enabler 43 may cause display 20 to display the display content indicating the changed driving plan, at a position more noticeable for the occupant (a position that improves the occupant's visibility). For vehicle 2 equipped with displays 20, display positions noticeable for the occupant are, for example, display 20 present in the occupant's gaze direction or display 20 present at the position at which the gaze of the occupant is frequently directed. For vehicle 2 equipped with one display 20, display positions noticeable for the occupant are, for example, a portion of display 20 present in the occupant's gaze direction and a portion of display 20 which the occupant can easily look at.

When driving plan setter 32 changes the driving plan, emphasis display enabler 43 may display flashing display content indicating the changed driving plan, to cause display 20 to display the changed driving plan in an emphasized manner. When the driving plan is changed, emphasis display enabler 43 may, for instance, change a lighting mode from the lighting mode of the display content indicating the driving plan prior to the change, to another lighting mode. Specifically, emphasis display enabler 43 may change the lighting mode of the display content indicating the changed driving plan, from a normal steady lighting mode to a flashing mode.

When driving plan setter 32 changes the driving plan, emphasis display enabler 43 may cause the display content indicating the changed driving plan to scroll seamlessly within display 20, to cause display 20 to display the changed driving plan in an emphasized manner. That is, when the driving plan is changed, emphasis display enabler 43 may change the display mode from the display mode of the display content indicating the driving plan prior to the change, to another display mode. Specifically, emphasis display enabler 43 may scroll the display content indicating the changed driving plan, from one side of display 20 to the opposite side.

When driving plan setter 32 changes the driving plan, emphasis display enabler 43 may cause display 20 to additionally display an icon representing the display content indicating the changed driving plan, to cause display 20 to display the changed driving plan in an emphasized manner.

When driving plan setter 32 changes the driving plan, emphasis display enabler 43 may display, as an animation, the display content indicating the changed driving plan, to cause display 20 to display the changed driving plan in an emphasized manner. That is, when the driving plan is changed, emphasis display enabler 43 may change the display mode from the display mode of the display content indicating the driving plan prior to the change, to another display mode. Specifically, emphasis display enabler 43 changes the display mode of the display content indicating the changed driving plan from static display to dynamic (animation) display.

When the driving plan is changed, emphasis display enabler 43 may cause display 20 to display the changed driving plan in an emphasized manner, by combining two or more of the aforementioned emphasis display methods.

When second display instructor 42 causes second display 22 to display scheduled operations, emphasis display enabler 43 may cause second display 22 to display the most immediate scheduled operation in an emphasized manner.

Display content displayed when the driving plan is changed by driving plan setter 32 is described below. Specifically, display content indicating a driving plan prior to the change, displayed on first display 21 and second display 22 as illustrated in (a) in FIG. 4 and display content indicating a changed driving plan, as illustrated in (b) in FIG. 4, are described below.

As illustrated in (a) in FIG. 4, first display 21 is displaying “2.6 km Manual”, “2.0 km Manual”, “1.6 km Autonomous” as scheduled operations prior to the change of the driving plan. In addition, second display 22 is displaying “1.6 km Autonomous” as a scheduled operation prior to the change of the driving plan. The scheduled operation displayed on second display 22 is the most immediate operation to be performed at a point around 1.6 km ahead from the present location, out of the scheduled operations displayed on first display 21.

When the driving plan is changed, as illustrated in (b) in FIG. 4, first display 21 is displaying “3.3 km Manual”, “2.4 km Autonomous”, and “1.8 km Manual” as scheduled operations after the driving plan is changed. Second display 22 is displaying “1.8 km Manual” as a scheduled operation after the driving plan is changed. The scheduled operation displayed on second display 22 is the most immediate operation to be performed at a point around 1.8 km ahead from the present location, out of the scheduled operations displayed on first display 21.

As illustrated in the hatch pattern in (b) in FIG. 4, when the driving plan is changed, emphasis display enabler 43 causes displays 20 to display the scheduled operations indicating the changed driving plan in an emphasized manner to make the display content more noticeable for the occupant. This makes it easier for the occupant to notice that the driving plan has been changed, via displays 20.

### <Processing Operation>

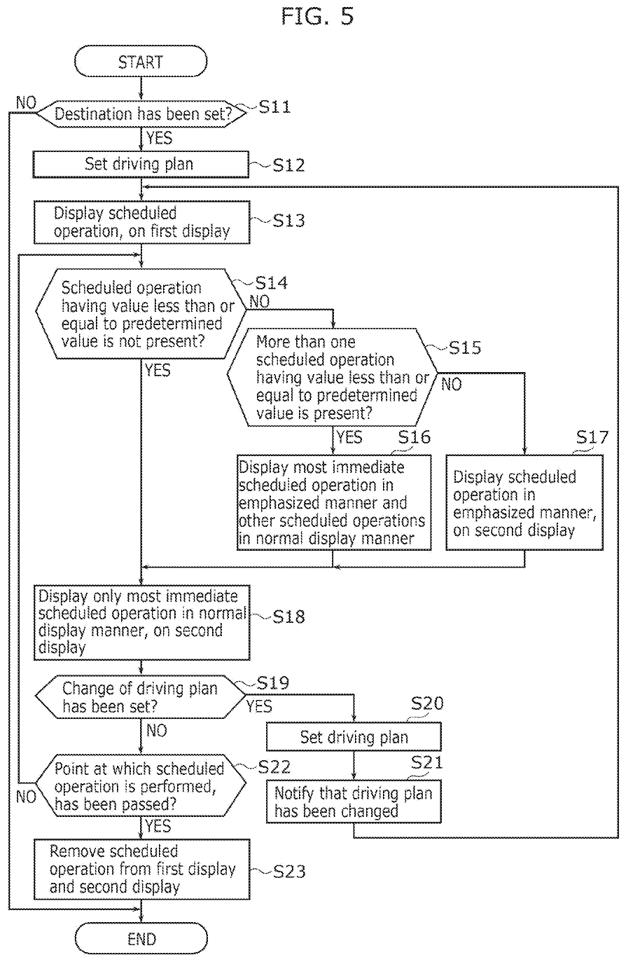

Processing operation of display control system 1 according to the embodiment is described with reference to FIG. 5.

FIG. 5 is a flowchart illustrating processing operation of display control system 1 according to the embodiment. The processing operation illustrated in FIG. 5 is performed by CPU 11 reading a display program from ROM 12 or storage 14, deploying the program on RAM 13, and running the program.

As illustrated in FIG. 5, CPU 11 determines whether a destination has been set (S11). That is, the destination may be directly input by the occupant to input-output interface 16 of vehicle 2, directly input via a portable terminal or another device, or indirectly input via communication interface 15.

When determining that the destination has been set (Yes in S11), CPU 11 sets the driving plan of vehicle 2 (S12). Specifically, CPU 11 sets the driving plan from a present location to the destination, by using the function of driving plan setter 32. Driving plan setter 32 achieved by CPU 11 may obtain, for example, information items regarding traffic conditions and an accident and reflect the information items regarding the traffic conditions and the accident when setting the driving plan. In addition, in response to an occupant's request input in advance, driving plan setter 32 may set a driving plan with a high proportion of autonomous driving.

Meanwhile, when determining that the destination has not been set (No in S11), CPU 11 ends the processing operation illustrated in the flowchart in FIG. 5.

CPU 11 causes first display 21 to display scheduled operations (S13). Specifically, by using the function of first display instructor 41, CPU 11 causes first display 21 to display the scheduled operations of vehicle 2, on the basis of the driving plan. For instance, CPU 11 causes the display area of first display 21 to display one or more scheduled operations.

CPU 11 determines whether there is a scheduled operation in which at least one of a distance traveled from a present location and the length of time from now until the scheduled operation is complete is less than or equal to a predetermined value (S14).

When a scheduled operation in which the at least one of the distance traveled from the present location and the length of time from now until the scheduled operation is complete is less than or equal to the predetermined value is not present (Yes in S14), CPU 11 causes second display 22 to display only the most immediate scheduled operation in a normal display manner (S18). Specifically, by using the function of second display instructor 42, CPU 11 causes second display 22 to display only the most immediate scheduled operation out of the scheduled operations displayed on first display 21. It should be noted that displaying in a normal display manner means displaying in a display mode that is not emphasis display. Only the scheduled operations are displayed on second display 22 in a normal display manner.

Meanwhile, when there is a scheduled operation in which the at least one of the distance traveled from the present location and the length of time from now until the scheduled operation is complete is less than or equal to the predetermined value (No in S14), CPU 11 determines whether there are scheduled operations in each of which at least one of the distance traveled from the present location and the length of time from now until the scheduled operation is complete is less than or equal to the predetermined value (S15).

When there are scheduled operations each of which has a value less than or equal to the predetermined value, out of the scheduled operations displayed on first display 21 (Yes in S15), CPU 11 causes display 20 to display the most immediate scheduled operation in an emphasized manner and the other scheduled operations in a normal display manner (S16). Specifically, by using the functions of second display instructor 42 and emphasis display enabler 43, CPU 11 causes second display 22 to display the scheduled operation in an emphasized manner. In addition, CPU 11 causes second display 22 to display the scheduled operations in a normal display manner. Then, CPU 11 performs the processing operation in step S18.

Meanwhile, two or more scheduled operations each of which has a value less than or equal to the predetermined value are not present among the scheduled operations displayed on first display 21 (No in S15), CPU 11 causes display 20 to display the scheduled operation in an emphasized manner (S17). For instance, by using the functions of first display instructor 41, second display instructor 42 and emphasis display enabler 43, CPU 11 causes first display 21 and second display 22 to display the scheduled operation in an emphasized manner. Then, CPU 11 performs the processing operation in step S18.

CPU 11 determines whether a change of the driving plan has been set using the function of driving plan setter 32 (S19).

When determining that a change of the driving plan has not been set using the function of driving plan setter 32 (No in S19), CPU 11 determines whether vehicle 2 has passed a scheduled-operation point (S22). Specifically, CPU 11 determines whether vehicle 2 has passed the scheduled-operation point, according to the relationship between the location of vehicle 2 identified by a GPS device (not illustrated) and the scheduled-operation point set on map data on the basis of the driving plan.

When determining that vehicle 2 has passed the scheduled-operation point (Yes in S22), CPU 11 removes the scheduled operation from first display 21 and second display 22 (S23). Specifically, as for the scheduled operation in which vehicle 2 has passed the scheduled-operation point, CPU 11 removes display content indicating the scheduled operation from first display 21 and second display 22. In this case, by the scheduled operation being removed from first display 21, first display 21 may display another scheduled operation. Likewise, by the scheduled operation being removed from second display 22, second display 22 may display another scheduled operation. Thus, by removing the completed scheduled operation, it is possible to reduce the amount of information displayed on displays 20, which enables the occupant to easily notice necessary display content.

When CPU 11 determines that vehicle 2 has not passed the scheduled-operation point (No in S22), the processing returns to step S14.

When it is determined in step S19 that a change of the driving plan has been set using the function of driving plan setter 32 (Yes in S19), CPU 11 changes the driving plan prior to the change to a changed driving plan, by using the function of driving plan setter 32, and sets the changed driving plan as the driving plan of vehicle 2 (S20).

When the changed driving plan has been set using the function of driving plan setter 32, CPU 11 notifies that the driving plan has been changed, by using the function of notification controller 34 (S21). When driving plan setter 32 changes the driving plan, first display instructor 41 notifies the notifier of the changed driving plan.

Specifically, when driving plan setter 32 changes the driving plan, first display instructor 41 may cause first display 21 to display the changed driving plan. When driving plan setter 32 changes the driving plan, second display instructor 42 may cause second display 22 to display the changed driving plan. When driving plan setter 32 changes the driving plan, audio equipment 23 may output the changed driving plan. When driving plan setter 32 changes the driving plan, vibrator 24 may vibrate at least one of the steering wheel, the seat, and other parts of the vehicle to notify that the driving plan has been changed. Then, the processing performed by CPU 11 returns to step S13.

### Advantageous Effects

Advantageous Effects of display control device 10, display control system 1, the display control method, and the program according to the embodiment are described below.

In the display control device for use in a vehicle disclosed in PTL 1, when the driving plan of the vehicle is changed, an occupant may not be able to notice that the driving plan has been changed.

However, as described above, display control device 10 according to the embodiment includes a processor and a memory including at least one program that, when executed by the processor, causes the processor to perform operations. The operations include setting the driving plan of vehicle 2 from a departure point to a destination, vehicle 2 being equipped with display 20, and controlling display 20 used for displaying the driving plan.

When the driving plan is changed, display 20 is caused to display a changed driving plan, by controlling display 20. The processor causes display 20 to display the changed driving plan in an emphasized manner when the driving plan is changed.

When the driving plan is changed, display 20 can display the changed driving plan for the occupant. When the driving plan is changed, the changed driving plan can be displayed in an emphasized manner, which makes it easier for the occupant to notice that the driving plan has been changed, via display 20. Thus, when the driving plan of vehicle 2 is changed, display control device 10 can display the change of the driving plan for the occupant. Accordingly, the occupant can be informed of the changed driving plan.

For instance, in a situation where the driving mode is soon to be switched from autonomous driving to manual driving, it is possible to notify the occupant that the driving plan of vehicle 2 has been changed. Thus, the occupant can respond to the situation by, for example, operating vehicle 2. This can improve the driving safety of vehicle 2.

In addition, display control system 1 according to the embodiment includes display control device 10 and one or more displays 20 included in vehicle 2.

Display control system 1 provides advantageous effects similar to those described above.

In addition, the display control method according to the embodiment includes setting the driving plan of vehicle 2 from a departure point to a destination, vehicle 2 being equipped with display 20, controlling display 20 used for displaying the driving plan, causing display 20 to display a changed driving plan, by controlling display 20, when the driving plan is changed, and causing display 20 to display the changed driving plan in an emphasized manner, when the driving plan is changed.

The display control method provides advantageous effects similar to those described above.

In addition, a program according to the embodiment is a program to be executed by a computer.

The program provides advantageous effects similar to those described above.

In addition, in display control device 10 according to the embodiment, when the driving plan is changed, the processor changes the color of display content indicating the changed driving plan, to cause display 20 to display the changed driving plan in an emphasized manner.

Thus, when the driving plan is changed, the color of the display content indicating the changed driving plan can be changed, which makes it easier for the occupant to notice that the driving plan has been changed, via display 20.

In addition, in display control device 10 according to the embodiment, when the driving plan is changed, the processor changes the character size of the display content indicating the changed driving plan, to cause display 20 to display the changed driving plan in an emphasized manner.

Thus, when the driving plan is changed, the character size of the display content indicating the changed driving plan can be changed, which makes it easier for the occupant to notice that the driving plan has been changed, via display 20.

In addition, in display control device 10 according to the embodiment, when the driving plan is changed, the processor changes the character font of the display content indicating the changed driving plan, to cause display 20 to display the changed driving plan in an emphasized manner.

Thus, when the driving plan is changed, the character font of the display content indicating the changed driving plan can be changed, which makes it easier for the occupant to notice that the driving plan has been changed, via display 20.

In addition, in display control device 10 according to the embodiment, when the driving plan is changed, the processor changes the display position of display content indicating the changed driving plan, to cause display 20 to display the changed driving plan in an emphasized manner.

Thus, when the driving plan is changed, the display position of the display content indicating the changed driving plan can be changed on display 20, which makes it easier for the occupant to notice that the driving plan has been changed, via display 20, without moving their gaze significantly.

In addition, in display control device 10 according to the embodiment, when the driving plan is changed, the processor causes display 20 to display flashing display content indicating the changed display plan, to cause display 20 to display the changed driving plan in an emphasized manner.

Thus, when the driving plan is changed, the flashing display content indicating the changed driving plan can be displayed, which makes it easier for the occupant to notice that the driving plan has been changed, via display 20.

In addition, in display control device 10 according to the embodiment, when the driving plan is changed, the processor causes the display content indicating the changed driving plan to scroll seamlessly within display 20, to cause display 20 to display the changed driving plan in an emphasized manner.

Thus, when the driving plan is changed, the display content indicating the changed driving plan is scrolled seamlessly, which makes it easier for the occupant to notice that the driving plan has been changed, via display 20.

In addition, in display control device 10 according to the embodiment, when the driving plan is changed, the processor causes display 20 to additionally display an icon representing the display content indicating the changed display plan, to cause display 20 to display the changed driving plan in an emphasized manner.

When the driving plan is changed, the display content indicating the changed driving plan is additionally displayed as an icon on display 20. This makes it easier for the occupant to notice that the driving plan has been changed, via display 20.

In addition, in display control device 10 according to the embodiment, when the driving plan is changed, the processor causes display 20 to display, as an animation, the display content indicating the changed display plan, to cause display 20 to display the changed driving plan in an emphasized manner.

Thus, when the driving plan is changed, the display content indicating the changed driving plan is displayed as an animation on display 20, which makes it easier for the occupant to notice that the driving plan has been changed, via display 20.

In display control device 10 according to the embodiment, vehicle 2 is equipped with audio equipment 23. When the driving plan is changed, the processor causes audio equipment 23 to output sound to emphasize the changed driving plan.

Thus, when the driving plan is changed, the display content indicating the changed driving plan is notified by sound. This makes it easier for the occupant to notice that the driving plan has been changed, via audio equipment 23.

In display control device 10 according to the embodiment, vehicle 2 is equipped with vibrator 24. When the driving plan is changed, the processor causes vibrator 24 to vibrate at least one of the steering wheel, the seat, and other parts of vehicle 2 to emphasize the changed driving plan.

Thus, when the driving plan is changed, the display content indicating the changed driving plan is notified by vibration. This makes it easier for the occupant to notice that the driving plan has been changed, via vibrator 24.

In display control device 10 according to the embodiment, when the driving plan is changed, the processor notifies the changed driving plan to terminal device 30 other than displays included in vehicle 2.

Thus, when the driving plan is changed, the display content indicating the changed driving plan is notified to terminal device 30 other than display 20. This makes it easier for the occupant to notice that the driving plan has been changed, via terminal device 30 other than display 20.

### Other Variations

The display control device, the display control system, the display control method, and the program according to the present disclosure are described on the basis of the embodiment. However, the present disclosure is not limited to the descriptions in the above embodiment. The present disclosure encompasses one or more embodiments obtained by making various changes conceived by those skilled in the art to the embodiment, within the scope of the present disclosure.

For instance, in the display control device, the display control system, the display control method, and the program according to the present disclosure, when a changed driving plan is displayed in an emphasized manner, an urgent driving plan may be displayed in an emphasized manner preferentially or displayed more noticeably by combining some of the aforementioned emphasis display methods, to make the driving plan more noticeable for an occupant. Examples of the urgent driving plan includes a situation in which a manual operation for a vehicle in an autonomous mode needs to be performed soon, because of a change of the driving plan.

In the display control device, the display control system, the display control method, and the program according to the present disclosure, when the driving plan is changed, the notification controller may cause a display to display the changed driving plan in an emphasized manner, by combining the aforementioned emphasis display methods. In addition, when the driving plan is changed, the notification controller may combine at least one emphasis display method out of the aforementioned emphasis methods, notification by the audio equipment, and/or notification by the vibrator. In addition, for the most immediate scheduled operation in which at least one of a distance traveled from a present location and the length of time from now until the scheduled operation is complete is less than or equal to the predetermined value, when the driving plan is an urgent driving plan, at least one emphasis display method, notification by the audio equipment, and/or notification by the vibrator may be combined. Thus, it is possible to promptly notify the occupant that the driving plan of the vehicle has been changed.

The display control device, the display control system, the display control method, and the program according to the present disclosure, when an occupant starts manually operating the vehicle after the display starts displaying in an emphasized manner, when a predetermined time period has elapsed since the display started displaying in an emphasized manner, or when the gaze of the occupant is directed at the display, the notification controller may control the emphasis display enabler to cause the display to stop displaying in an emphasized manner or may cause the audio equipment and the vibrator to stop notifying. In this case, the occupant's manual operation may be performed by the notification controller obtaining an operation signal from the ECU included in the vehicle. A predetermined time period may be measured using a clocking unit. In addition, the gaze of the occupant may be detected by using a sensor that detects the gaze of the occupant.

In the display control device, the display control system, the display control method, and the program according to the present disclosure, when the driving mode of the vehicle changes from an autonomous driving mode to a manual driving mode and when the driving mode changes from the manual driving mode to the autonomous driving mode, at least one emphasis display method, notification by the audio equipment, and/or notification by the vibrator may be combined. In addition, the level of emphasis when the driving mode changes from the autonomous driving mode to the manual driving mode may be higher than the level of emphasis when the driving mode changes from the manual driving mode to the autonomous driving mode.

In the display control device, the display control system, the display control method, and the program according to the present disclosure, when a device, such as a smartphone, a smartwatch, or a virtual reality (VR) goggle, is linked with the vehicle, the occupant may be notified that the driving plan has been changed, via the device in combination with at least one of the aforementioned emphasis display methods.

The display control device, the display control system, the display control method, and the program described above embodiment are typically embodied as large-scale integrations (LSIs), which are integrated circuits. The elements of, for example, the display control device may be made as individual chips, or a part or all of the elements may be incorporated into one chip.

Circuit integration is achieved not only by an LSI but also by a dedicated circuit or a general-purpose processor. A field programmable gate array (FPGA) which can be programmed after manufacturing an LSI or a reconfigurable processor in which the connections and settings of circuit cells inside an LSI are reconfigurable may be used.

It should be noted that in the embodiment, each of the structural elements may be dedicated hardware or may be caused to function by executing a software program suitable for the structural element. The structural element may be caused to function by a program executer, such as a CPU or a processor, reading and executing a software program stored in a recording medium, such as a hard disk or semiconductor memory.

All the numbers used in the above descriptions are provided as examples to specifically explain the present disclosure. In the embodiment in the present disclosure, the numbers are provided for purposes of illustration and not limitation.

The configuration of the functional blocks illustrated in the block diagram is a mere example. Two or more functional blocks may be incorporated into one functional block. One functional block may be divided into more than one functional block. A part of the function may be transferred from one functional block to another functional block. The same hardware or software may process, in parallel or on a time-sharing basis, the functions of two or more functional blocks having similar functions.

The order in which the steps in the flowchart are performed is provided as an example to specifically explain the present disclosure. The steps may be performed in a different order. In addition, a part of the steps and another step may be performed simultaneously (in parallel).

It should be noted that the present disclosure includes one or more embodiments obtained by making various changes conceived by those skilled in the art to the embodiment and one or more embodiments obtained within the scope of the present disclosure through any combination of the structural elements and the functions described in the embodiment.

### Supplementary Note

The features of the display control device, the display control system, the display control method, and a program described on the basis of the above embodiment are described below.

### <Technique 1>

A display control device including:
a processor; and
a memory including at least one program that, when executed by the processor, causes the processor to perform operations, the operation including:
   setting the driving plan of a vehicle from a departure point to a destination, the vehicle being equipped with a display; and
   controlling the display used for displaying the driving plan,
   in which when the driving plan is changed, the display is caused to display a changed driving plan, by controlling the display, and
   the processor causes the display to display the changed driving plan in an emphasized manner when the driving plan is changed.

### <Technique 2>

The display control device according to technique 1,
in which when the driving plan is changed, the processor changes the color of display content indicating the changed driving plan, to cause the display to display the changed driving plan in the emphasized manner.

### <Technique 3>

The display control device according to technique 1 or 2,
in which when the driving plan is changed, the processor changes the character size of display content indicating the changed driving plan, to cause the display to display the changed driving plan in the emphasized manner.

### <Technique 4>

The display control device according to any one of techniques 1 to 3,
in which when the driving plan is changed, the processor changes the character font of display content indicating the changed driving plan, to cause the display to display the changed driving plan in the emphasized manner.

### <Technique 5>

The display control device according to any one of techniques 1 to 4,
in which when the driving plan is changed, the processor changes the display position of display content indicating the changed driving plan, to cause the display to display the changed driving plan in the emphasized manner.

### <Technique 6>

The display control device according to any one of techniques 1 to 5,
in which when the driving plan is changed, the processor causes the display to display flashing display content indicating the changed driving plan, to cause the display to display the changed driving plan in the emphasized manner.

### <Technique 7>

The display control device according to any one of techniques 1 to 6,
in which when the driving plan is changed, the processor causes display content indicating the changed driving plan to scroll seamlessly within the display, to cause the display to display the changed driving plan in the emphasized manner.

### <Technique 8>

The display control device according to any one of techniques 1 to 7,
in which when the driving plan is changed, the processor causes the display to additionally display an icon representing display content indicating the changed driving plan, to cause the display to display the changed driving plan in the emphasized manner.

### <Technique 9>

The display control device according to any one of techniques 1 to 8,
in which when the driving plan is changed, the processor causes the display to display, as an animation, display content indicating the changed driving plan, to cause the display to display the changed driving plan in the emphasized manner.

### <Technique 10>

The display control device according to any one of techniques 1 to 9,
in which the vehicle is equipped with audio equipment, and when the driving plan is changed, the processor causes the audio equipment to output sound to emphasize the changed driving plan.

### <Technique 11>

The display control device according to any one of techniques 1 to 10,
in which the vehicle is equipped with a vibrator, and
when the driving plan is changed, the processor causes the vibrator to vibrate at least one of the steering wheel or a seat of the vehicle to emphasize the changed driving plan.

### <Technique 12>

The display control device according to any one of techniques 1 to 11,
in which when the driving plan is changed, the processor notifies the changed driving plan to a terminal device other than the display included in the vehicle.

### <Technique 13>

The display control device according to any one of techniques 1 to 12,
in which when an occupant starts manually operating the vehicle after the processor starts causing the display to display the changed driving plan in the emphasized manner, the processor causes the display to stop displaying in the emphasized manner.

### <Technique 14>

The display control device according to any one of techniques 1 to 13,
in which when a predetermined period has elapsed since the processor started causing the display to display the changed driving plan in the emphasized manner, the processor causes the display to stop displaying in the emphasized manner.

### <Technique 15>

The display control device according to any one of techniques 1 to 14,
in which when the gaze of an occupant is directed at the display after the processor starts causing the display to display the changed driving plan in the emphasized manner, the processor causes the display to stop displaying in the emphasized manner.

### <Technique 16>

The display control device according to any one of techniques 1 to 15,
in which the vehicle is equipped with audio equipment and a vibrator, and
before the vehicle switches from an autonomous driving mode to a manual driving mode or from the manual driving mode to the autonomous driving mode, the processor performs at least one of:
   control to cause the display to stop displaying in the emphasized manner;
   control to cause the audio equipment to notify the changed driving plan; or
   control to cause the vibrator to notify the changed driving plan.

### <Technique 17>

The display control device according to any one of techniques 1 to 16,
in which the vehicle is equipped with a vibrator, and
when the driving plan is changed, the processor performs at least one of:
   control to cause the vibrator to vibrate at least one of the steering wheel or a seat of the vehicle to emphasize the changed driving plan; or
   control to notify the changed driving plan to a terminal device other than the display included in the vehicle.

### <Technique 18>

A display control system including:
the display control device according to any one of techniques 1 to 17,
one or more displays included in the vehicle.

### <Technique 19>

A display control method including:
setting the driving plan of a vehicle from a departure point to a destination, the vehicle being equipped with a display;
controlling the display used for displaying the driving plan;
causing the display to display a changed driving plan, by controlling the display, when the driving plan is changed; and
causing the display to display the changed driving plan in an emphasized manner, when the driving plan is changed.

### <Technique 20>

A non-transitory computer-readable storage medium having recorded thereon a program for causing a computer to execute the display control method according to technique 19.

While an embodiment has been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in their entirety: Japanese Patent Application No. 2022-176087 filed on Nov. 2, 2022.

### Industrial Applicability

The present disclosure can be used in, for example, a vehicle equipped with one or more displays and a device and a system other than the vehicle.

1. A display control device comprising:
a processor; and
a memory including at least one program that, when executed by the processor, causes the processor to perform operations, the operations including:
setting a driving plan of a vehicle from a departure point to a destination, the vehicle being equipped with a display; and
controlling the display used for displaying the driving plan,
wherein when the driving plan is changed, the display is caused to display a changed driving plan, by controlling the display, and
the processor causes the display to display the changed driving plan in an emphasized manner when the driving plan is changed.

2. The display control device according to claim 1,
wherein when the driving plan is changed, the processor changes a color of display content indicating the changed driving plan, to cause the display to display the changed driving plan in the emphasized manner.

3. The display control device according to claim 1,
wherein when the driving plan is changed, the processor changes a character size of display content indicating the changed driving plan, to cause the display to display the changed driving plan in the emphasized manner.

4. The display control device according to claim 1,
wherein when the driving plan is changed, the processor changes a character font of display content indicating the changed driving plan, to cause the display to display the changed driving plan in the emphasized manner.

5. The display control device according to claim 1,
wherein when the driving plan is changed, the processor changes a display position of display content indicating the changed driving plan, to cause the display to display the changed driving plan in the emphasized manner.

6. The display control device according to claim 1,
wherein when the driving plan is changed, the processor causes the display to display flashing display content indicating the changed driving plan, to cause the display to display the changed driving plan in the emphasized manner.

7. The display control device according to claim 1,
wherein when the driving plan is changed, the processor causes display content indicating the changed driving plan to scroll seamlessly within the display, to cause the display to display the changed driving plan in the emphasized manner.

8. The display control device according to claim 1,
wherein when the driving plan is changed, the processor causes the display to additionally display an icon representing display content indicating the changed driving plan, to cause the display to display the changed driving plan in the emphasized manner.

9. The display control device according to claim 1,
wherein when the driving plan is changed, the processor causes the display to display, as an animation, display content indicating the changed driving plan, to cause the display to display the changed driving plan in the emphasized manner.

10. The display control device according to claim 1,
wherein the vehicle is equipped with audio equipment, and
when the driving plan is changed, the processor causes the audio equipment to output sound to emphasize the changed driving plan.

11. The display control device according to claim 1,
wherein the vehicle is equipped with a vibrator, and
when the driving plan is changed, the processor causes the vibrator to vibrate at least one of a steering wheel or a seat of the vehicle to emphasize the changed driving plan.

12. The display control device according to claim 1,
wherein when the driving plan is changed, the processor notifies the changed driving plan to a terminal device other than the display included in the vehicle.

13. The display control device according to claim 1,
wherein when an occupant starts manually operating the vehicle after the processor starts causing the display to display the changed driving plan in the emphasized manner, the processor causes the display to stop displaying in the emphasized manner.

14. The display control device according to claim 1,
wherein when a predetermined period has elapsed since the processor started causing the display to display the changed driving plan in the emphasized manner, the processor causes the display to stop displaying in the emphasized manner.

15. The display control device according to claim 1,
wherein when a gaze of an occupant is directed at the display after the processor starts causing the display to display the changed driving plan in the emphasized manner, the processor causes the display to stop displaying in the emphasized manner.

16. The display control device according to claim 1,
wherein the vehicle is equipped with audio equipment and a vibrator, and
before the vehicle switches from an autonomous driving mode to a manual driving mode or from the manual driving mode to the autonomous driving mode, the processor performs at least one of:
control to cause the display to stop displaying in the emphasized manner;
control to cause the audio equipment to notify the changed driving plan; or
control to cause the vibrator to notify the changed driving plan.

17. The display control device according to claim 1,
wherein the vehicle is equipped with a vibrator, and
when the driving plan is changed, the processor performs at least one of:
control to cause the vibrator to vibrate at least one of a steering wheel or a seat of the vehicle to emphasize the changed driving plan; or
control to notify the changed driving plan to a terminal device other than the display included in the vehicle.

18. A display control system comprising:
the display control device according to claim 1; and
one or more displays included in the vehicle.

19. A display control method comprising:
setting a driving plan of a vehicle from a departure point to a destination, the vehicle being equipped with a display;
controlling the display used for displaying the driving plan;
causing the display to display a changed driving plan, by controlling the display, when the driving plan is changed; and
causing the display to display the changed driving plan in an emphasized manner, when the driving plan is changed.

20. A non-transitory computer-readable storage medium having recorded thereon a program for causing a computer to execute the display control method according to claim 19.
